(19) United States
(12) Patent Application Publication
(10) Pub. No.: US 2016/0312533 A1
(43) Pub. Date: Oct. 27, 2016

(54) GATE INSTALLING SYSTEM

(71) Applicant: John OH, Stanton, CA (US)

(72) Inventor: John OH, Stanton, CA (US)

(21) Appl. No.: 14/696,174

(22) Filed: Apr. 24, 2015

(51) Int. Cl. E06B 11/04; E06B 11/02; E05D 7/00; E06B 3/34; E05D 11/00

(52) U.S. Cl. CPC E06B 11/04; E06B 3/34; E05D 11/00; E05D 7/0009; E06B 11/025; E05D 2700/00

(57) ABSTRACT

A gate installing system includes a male swing bracket, a horizontal female receptacle, and a female swing bracket. The male swing bracket has a head portion, an adjustable fastening portion extended horizontally from the head portion, and a vertical swing axle portion extending downward from the head portion. The horizontal female receptacle receives and engages adjustably with the fastening portion of the male swing bracket. The female swing bracket has a fixed-type fastening portion for fastening to an anchor frame and a vertical female receptacle opening upward and for receiving and engaging rotatably with the vertical swing axle portion. The male swing bracket is fixed to the gate frame and the female swing bracket is fixed to the anchor frame, so that the vertical swing axle portion of the male swing bracket engages rotatably with the vertical female receptacle of the female swing bracket.

### BACKGROUND OF THE INVENTION

The present invention relates to a gate installing system.

Gates are produced in many sizes just like the various sizes of opening for the gate.

These difficulties are more outstanding and frequent with so-called ornamental gates.

Accordingly, a need for a gate installing system has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a gate installing system.

A gate installing system for a gate frame comprises a male swing bracket, a horizontal female receptacle, and a female swing bracket.

The male swing bracket has a head portion, an adjustable fastening portion extended horizontally from the head portion, and a vertical swing axle portion extending downward from the head portion.

The horizontal female receptacle is disposed in the gate frame and configured for receiving and engaging adjustably with the fastening portion of the male swing bracket.

The female swing bracket has a fixed-type fastening portion configured for fastening to an anchor frame and a vertical female receptacle opening upward and configured for receiving and engaging rotatably with the vertical swing axle portion.

The male swing bracket is fixed to the gate frame and the female swing bracket is fixed to the anchor frame, so that the vertical swing axle portion of the male swing bracket engages rotatably with the vertical female receptacle of the female swing bracket so as to swing open and close the gate.

The adjustable fastening portion of the male swing bracket may include male threads, and the horizontal female receptacle includes female threads.

The horizontal female receptacle may further comprise a through-hole and the female threads are provided on the inner surface of the through-hole.

The male swing bracket may be formed monolithically.

The gate installing system of claim 1, wherein the horizontal female receptacle is configured to be fixed to the gate frame.

The female swing bracket is formed monolithically.

The gate installing system may further comprise a wall bracket disposed between the anchor frame and a wall and for fixing the anchor frame to the wall.

The gate installing system may further comprise a wall-bracket receptacle configured for being fixed to the anchor frame and receiving and engaging adjustably with the wall bracket.

The wall-bracket receptacle may further comprise a through-hole and the female threads are provided on the inner surface of the through-hole.

The wall bracket may comprise one or more fasteners configured to be fixed to the wall.

A lower portion of the anchor frame may be fixed to a foundation or floor.

The advantages of the present invention are: (1) the gate installing system according to the invention enables the user's choice of gate flexible; and (2) the gate installing system can be installed with little limitation to the size of opening in the wall.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a partially cross-sectional view showing a gate installing system according to an embodiment of the invention;

FIG. 2 is a side view showing a male swing bracket and a horizontal female receptacle assembled to a gate frame according to another embodiment of the invention;

FIG. 3 is a side view showing a wall bracket and a wall-bracket receptacle assembled to an anchor frame according to still another embodiment of the invention; and

FIG. 4 is a front view of a gate.

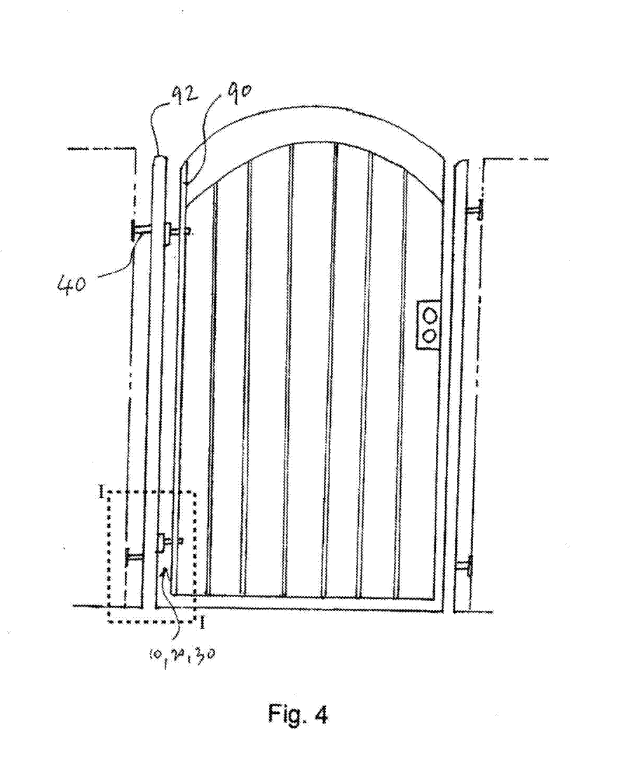

### DETAILED DESCRIPTION EMBODIMENTS OF THE INVENTION

Referring to the figures, the embodiments of the invention are described in detail.

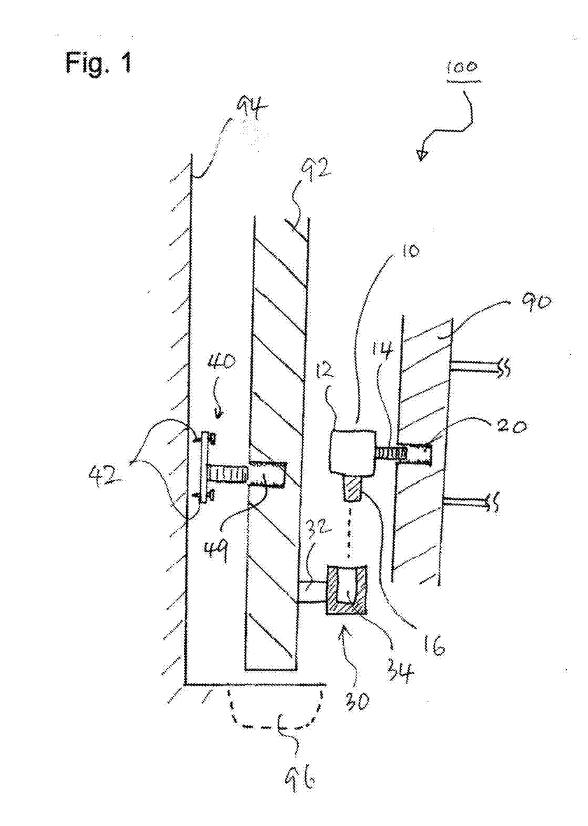

An aspect of the invention provides a gate installing system 100 for a gate frame 90 comprises a male swing bracket 10, a horizontal female receptacle 20, and a female swing bracket 30 as shown in FIGS. 1-3.

The male swing bracket 10 has a head portion 12, an adjustable fastening portion 14 extended horizontally from the head portion 12, and a vertical swing axle portion 16 extending downward from the head portion 12. In certain embodiments, the head portion 12 and the adjustable fastening portion 14 may be provided integrally.

The horizontal female receptacle 20 is disposed in the gate frame 90 and configured for receiving and engaging adjustably with the fastening portion 14 of the male swing bracket 10.

The female swing bracket 30 has a fixed-type fastening portion 32 configured for fastening to an anchor frame 92 and a vertical female receptacle 34 opening upward and configured for receiving and engaging rotatably with the vertical swing axle portion 16 of the male swing bracket 10.

The male swing bracket 10 is fixed to the gate frame 90 and the female swing bracket 30 is fixed to the anchor frame 92, so that the vertical swing axle portion 16 of the male swing bracket 10 engages rotatably with the vertical female receptacle 34 of the female swing bracket 30 so as to swing open and close the gate.

Of course, there may be more than one pair of the male swing bracket 10 and the female swing bracket 30 for installing the gate the anchor frame 90. That is, FIG. 1 may show a lower portion only of the gate installing system 100.

The adjustable fastening portion 14 of the male swing bracket 10 may include male threads, and the horizontal female receptacle includes female threads as illustrated briefly. Technically, the engaging structure may be reversed, so that the adjustable fastening portion 14 be a part to be fixed to gate frame 90 and another female receptacle may be provided through the head portion 12 of the male swing bracket 10. This kind of male/female structure change may be applied to other parts of the gate installing system 100, even to the male swing bracket 10 and the female swing bracket 30.

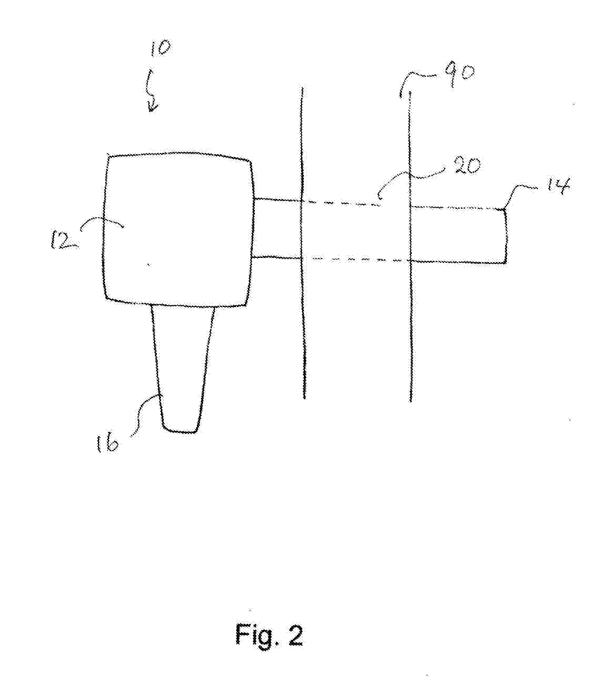

The horizontal female receptacle 20 may further comprise a through-hole as shown in FIG. 2, and the female threads are provided on the inner surface of the through-hole. That way, the interval between the gate frame 90 and the anchor frame 92 can be adjusted, so that the width of the gate may be flexible with respect to the opening in the wall.

The male swing bracket 10 may be formed monolithically. Alternatively, the portions of the male swing bracket 10 can be made separately and then assembled in a fixed fashion.

The horizontal female receptacle 20 may be configured to be fixed to the gate frame 90. In certain embodiments of the invention, the horizontal female receptacle 20 can be buried or embedded in the gate frame 90.

Likewise, the female swing bracket 20 is formed monolithically.

The gate installing system 100 may further comprise a wall bracket 40 disposed between the anchor frame 92 and a wall 94 and for fixing the anchor frame 92 to the wall 94 as shown in FIG. 1.

The gate installing system 100 may further comprise a wall-bracket receptacle 49 configured for being fixed to the anchor frame 92 and receiving and engaging adjustably with the wall bracket 40 as shown in FIG. 1.

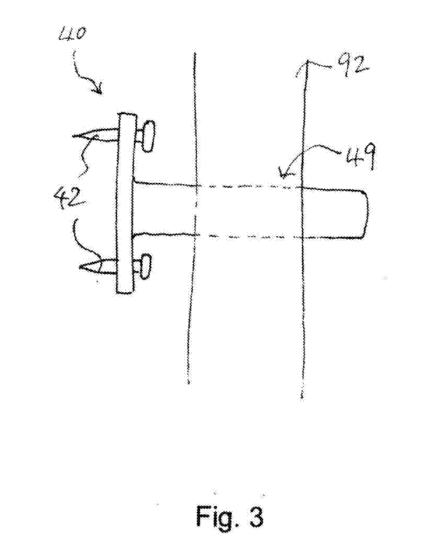

The wall-bracket receptacle 49 may further comprise a through-hole as shown in FIG. 3, and the female threads may be provided on the inner surface of the through-hole.

The wall bracket 40 may comprise one or more fasteners 42 configured to be fixed to the wall 90.

A lower portion of the anchor frame 92 may be fixed to a foundation or floor. In certain embodiments of the invention, the anchor frame 92 may be bolstered by a buried concrete 96 below as shown in FIG. 1.

The male swing bracket 10 has a fastener (can be a screw) to the gate frame and vertical swing axle.

The horizontal female receptacle 20 is provided in the gate frame 90 (sometime can be all the way through to accommodate a longer screw).

The female swing bracket 20 having a vertical receptacle 34 is attached at the anchor frame 92.

The wall bracket 40 for attaching the anchor frame 92 to the wall 94 (has been used before).

The anchor frame 92 can be buried in the foundation or floor(optional, could be free-attached).

This type of gates are called “ornamental gate”. With the gate installing system according to the invention, customers can actually takes the picture of the space and send in an order for the shop to custom make the gate. Now, with up to 4″ or more adjustment in the installing space, the gate could easily be customized.

Also, it enables easy repairs. Customer can remove all parts in the gate for easy repairs & easy painting.

In certain embodiments, ball joints can be used at one end of the bolt.

With the gate installing system 100, the interval between the the gate frame 90 and the anchor frame 92 can be adjusted, and further the interval between the anchor frame 92 and the wall 94 can be adjusted conveniently.

While the invention has been shown and described with reference to different embodiments thereof, it will be appreciated by those skilled in the art that variations in form, detail, compositions and operation may be made without departing from the spirit and scope of the invention as defined by the accompanying claims.

1. A gate installing system for a gate frame comprising:
a male swing bracket having a head portion, a fastening portion extended horizontally from the head portion, and a vertical swing axle portion extending downward from the head portion;
a horizontal female receptacle disposed and embedded in the gate frame and configured for receiving and engaging adjustably with the fastening portion of the male swing bracket, wherein the fastening portion of the male swing bracket is configured to engage the horizontal female receptacle adjustably;
a female swing bracket having a fastening portion configured for fastening to an anchor frame and a vertical female receptacle opening upward and configured for receiving and engaging rotatably with the vertical swing axle portion; and
a wall-bracket receptacle configured for being connected to the anchor frame and receiving and engaging with the wall bracket so that the anchor frame is installed adjustably with respect to the wall, so as to be fixed to the wall,
wherein the male swing bracket is fixed to the gate frame and the female swing bracket is fixed to the anchor frame, so that the vertical swing axle portion of the male swing bracket engages rotatably with the vertical female receptacle of the female swing bracket so as to swing open and close a gate,
wherein the fastening portion of the male swing bracket includes male threads and the horizontal female receptacle includes female threads,
where in the interval between the the gate frame and the anchor frame is adjusted, and further the interval between the anchor frame and the wall is adjusted while installing of the gate.

2. (canceled)

3. The gate installing system of claim 1, wherein the horizontal female receptacle further comprises a through-hole and the female threads are provided on an inner surface of the through-hole.

4. The gate installing system of claim 1, wherein the male swing bracket is formed monolithically.

5. The gate installing system of claim 1, wherein the horizontal female receptacle is configured to be fixed to the gate frame.

6. The gate installing system of claim 1, wherein the female swing bracket is formed monolithically.

7. The gate installing system of claim 1, further comprising a wall bracket disposed between the anchor frame and a wall and for fixing the anchor frame to the wall.

8. (canceled)

9. The gate installing system of claim 1, wherein the wall-bracket receptacle further comprises a through-hole and female threads are provided on an inner surface of the through-hole.

10. The gate installing system of claim 1, wherein the wall bracket comprises one or more fasteners configured to be fixed to the wall.

11. The gate installing system of claim 7, wherein a lower portion of the anchor frame is fixed to a foundation or floor at an adjusted position.
